(19) United States
(12) Patent Application Publication
(10) Pub. No.: US 2015/0095022 A1
(43) Pub. Date: Apr. 2, 2015

(54) LIST RECOGNIZING METHOD AND LIST RECOGNIZING SYSTEM

(71) Applicants: Founder Apabi Technology Limited, Beijing (CN); Peking University Founder Group Co., Ltd., Beijing (CN)

(72) Inventors: Canhui XU, Beijing (CN); Zhi TANG, Beijing (CN); Jianbo XU, Beijing (CN); Xin TAO, Beijing (CN)

(73) Assignees: Founder Apabi Technology Limited, Beijing (CN); Peking University Founder Group Co., Ltd., Beijing (CN)

(21) Appl. No.: 14/096,431

(22) Filed: Dec. 4, 2013

(30) Foreign Application Priority Data
Sep. 29, 2013 (CN) 201310455068.4

(51) Int. Cl. G06F 17/27

(52) U.S. Cl. CPC G06F 17/2765; G06F 17/2735
USPC 704/10

(57) ABSTRACT

A list recognizing method and system, which comprises: parsing and analyzing metadata information within an original fixed-layout document, and extracting basic elements within a page; segmenting the basic elements, extracting segmented text lines within the page to obtain fragments; building an undirected graph with respect to the fragments; detecting indent features of a bullet according to features of the basic elements; training a learning model according to the indent features, local features of the fragments and neighborhood relation features among the fragments, obtaining model parameters, and establishing a list recognizing model; and invoking the list recognizing model to perform list recognizing on the required document, so as to get recognition result. This machine learning method may recognize not only a list, but also the contextual relationship between the first line and its subsequent lines of a list, and realize analyzing and understanding a layout of the list of the fixed-layout document ultimately. The accuracy of list recognizing on a fixed-layout document can be improved even if the bullets of the first line of the list are various.

This application claims benefit of Serial No. 201310455068.4, filed 29 Sep. 2013 in China and which application is incorporated herein by reference. To the extent appropriate, a claim of priority is made to each of the above disclosed applications.

### BACKGROUND OF THE INVENTION

1. Field of the Invention

The present invention relates to an electronic document format converting technology, and more particularly to a list recognizing method, a list recognizing system, and a non-transitory storage medium storing programs executed by a computer to realize a list recognizing method.

2. Description of the Prior Art

According to a generation process of a fixed-layout document, the document is a collection of data and structure and specifically includes content data, physical structures and logic structures. Document analyzing is for extracting the physical structure of the document, while document understanding is for establishing a map relationship between the physical structure and the logic structure. In an actual application, it is particularly important to recover the physical structure and the logic structure for readable requirements of a mobile device. A major focus on the document understanding will be on detecting and recognizing lists within a page. The lists have their own independent logic functions which require physical dividing and logical labeling. But the lists have very similar characteristics in vision to the body text, and initial symbolic or numerical bullets signalizing the first line of the list item are various. There are not clear distinguishing characteristics for continuing lines of list item. Consequently, the performance of rigid rule based list item recognition methods cannot meet the practical needs.

Lists are an important part of a document, and recognizing lists and the contents in the lists is especially important to the fixed-layout document analysis and understanding. There proposed some methods which may recognize and convert the lists of the fixed-layout document, for example, detecting at least one list in a document based on vector graphs by using a set of rules, in the conventional technology. A mode detection identifies like various characters, signatures, numbers, alphabets and/or images which may initiate a list, and the other mode detecting symbols determine whether or not a list is presented. The system may identify and analyze a list marked with bullets, a list marked with numbers or alphabets, and a nested list as any combination of these two. The shortage of this method is that neighborhood features comprising text patterns, indent levels, punctuations, alignments and the like have not been considered, and it may not recognize a contextual relationship between the first line and its subsequent lines of the list, when there are a plurality of lists in document pages, which results in the whole recognition effect is not ideal.

### SUMMARY OF THE INVENTION

With regards to this, the technical problem which the present invention is to solve is that the list recognizing method in the art may not recognize a context relationship between the first line and its subsequent lines of the list, thereby a method, which may recognize the first line and its subsequent lines of the list and is based on the probability graph model, is proposed.

In order to solve the problem, the embodiments of the present invention supply a list recognizing method and a list recognizing system based on the probability graph model.

The list recognizing method may comprise the following steps:

parsing and analyzing metadata information within an original fixed-layout document, and extracting basic elements within a page;

segmenting the basic elements, extracting segmented text lines within the page to obtain fragments;

building an undirected graph with respect to the fragments;

detecting indent features of initial symbolic or numerical bullets according to features of the basic elements;

training a learning model according to the indent features, local features of the fragments and neighborhood relation features among the fragments, obtaining model parameters, and establishing a list recognizing model; and

invoking the list recognizing model to perform list recognizing on the required document, so as to get recognition results.

Alternatively, the training a learning model according to the indent, local features of the fragments and the neighborhood relation features among the fragments, obtaining model parameters, and establishing a list recognizing model may comprise:

extracting the local features of each of the fragments in the undirected graph, classifying the local features and converting scores of classifications into a pseudo-probability function used as a unary feature function of a Conditional Random Fields (CRF) model; and

extracting the neighborhood relation features among the fragments as a binary feature function according to neighborhood relations of the undirected graph,

wherein the learning model is a CRF model.

Alternatively, the segmenting the basic elements, extracting segmented text lines within the page to obtain fragments may comprise: segmenting continuous texts in the text lines into one fragment.

Alternatively, the extracting segmented text lines within the page may comprise: using clustering method for extracting segmented text lines.

Alternatively, the building an undirected graph with respect to the fragments may comprise: building the undirected graph by using the neighborhood relations among the fragments.

Alternatively, the building an undirected graph with respect to the fragments may comprise: using a MST method or a triangulation method to build the undirected graph.

Alternatively, the detecting indent features of initial symbolic or numerical bullets according to features of the basic elements may comprise: detecting indent level of the initial symbolic or numerical bullets, relative indents and whether the indents of the bullets is identical to those of other bullets.

Alternatively, the local features of the fragments may comprise a length-width ratio, a normalized area, an indent level, and image texture features of the fragments.

Alternatively, the extracting the local features of each of the fragments in the undirected graph, classifying the local features and converting scores of classifications into a pseudo-probability function may comprise: classifying by a Support Vector Machine (SVM) classifier, selecting a Radial Basis Function (RBF), and converting the scores of the classifications into the pseudo-probability function.

Alternatively, the indent features may comprise an indent level of the bullet, relative indents and whether the indents of the bullet is identical to those of other bullets.

The list recognizing system may comprise:

an extracting unit, configured to parse and analyze metadata information within an original fixed-layout document, and extract basic elements within a page;

a segmenting unit, configured to segment the basic elements, extract segmented text lines within the page to obtain fragments;

a building unit, configured to build an undirected graph with respect to the fragments;

a detecting unit, configured to detect indent features of a bullet according to features of the basic elements;

a modeling unit, configured to train a learning model according to the indent features, local features of the fragments and neighborhood relation features among the fragments, obtain model parameters, and establish a list recognizing model; and

an invoking unit, configured to invoke the list recognizing model to perform list recognizing on the required document, so as to get recognition results.

Alternatively, the modeling unit may comprise:

a first feature extraction subunit, configured to extract the local features of each of the fragments in the undirected graph, classify the local features and convert scores of classifications into a pseudo-probability function used as a unary feature function of a CRF model;

a second feature extraction subunit, configured to extract the neighborhood relation features among the fragments as a binary feature function according to neighborhood relations of the undirected graph,

wherein the learning model is a CRF model.

Alternatively, the segmenting unit may be configured to segment continuous texts in the text lines into one fragment.

Alternatively, the extracting unit may be configured to extract the segmented text lines by using a clustering method.

Alternatively, the building unit may be configured to build the undirected graph by using the neighborhood relations among the fragments.

Alternatively, the building unit may be configured to use a MST method or a triangulation method to build the undirected graph.

Alternatively, the detecting unit may be configured to detect indent level of the bullet, relative indents and whether the indents of the bullet are identical to those of other bullets.

Alternatively, the local features of the fragments may comprise a length-width ratio, a normalized area, an indent level, and image texture features of the fragments.

Alternatively, the first feature extraction subunit may be configured to classify by a SVM classifier, select RBF, and convert the scores of the classifications into the pseudo-probability function.

Alternatively, the indent features may comprise an indent level of the bullet, relative indents and whether the indents of the bullet are identical to those of other bullets.

Compared with the prior art, the embodiments of the present invention have the following advantages:

(1) The list recognizing method and system provided by the embodiments of the present invention comprise: parsing and analyzing metadata information within an original fixed-layout document, and extracting basic elements within a page; segmenting the basic elements, extracting segmented text lines within the page to obtain fragments; building an undirected graph with respect to the fragments; detecting indent features of a bullet according to features of the basic elements; training a learning model according to the indent features, local features of the fragments and neighborhood relation features among the fragments, obtaining model parameters, and establishing a list recognizing model; and invoking the list recognizing model to perform list recognizing on the required document, so as to get recognition results. Based on the above method and system, it extracts lists, calibrates the lists by logic labels according to the logic functions, and a machine learning may recognize not only a list, but also the context relationship between the first line and its subsequent lines of a list, and realize analyzing and understanding the layout of lists of the fixed-layout document ultimately. The accuracy of list recognizing on a fixed-layout document can be improved by analyzing the list logic function for recognizing even if the bullets of the first line of the list are various.

(2) The list recognizing method according to the embodiment of the present invention uses a CRF model in which the unary feature function is obtained according to the local features of the fragments, and the binary feature function is obtained by the neighborhood relation features, and the multivariate characteristic design is comprised of the unary local features and the binary neighborhood features, and accordingly the CRF model may be trained. The unary features come from the features of the fragments themselves mainly, and the binary features come from the features of relationship of the neighbor fragments of the undirected graph mainly. The object function of the CRF model is a negative log-likelihood function. The usage of multivariate characteristic and a plurality of context information can greatly reduce the negative impact on final marks due to the uncertainty and fuzzy of the label classification.

(3) In the list recognizing method according to the embodiment of the present invention, the segmenting step may comprise: segmenting the continuous texts in text lines into one fragment, segmenting according to the text elements, the image elements, and primitive graphic operation elements so as to obtain the fragments, and putting those elements with more relevance into one fragment so that the foundation for building undirected graphs and extracting the features of the fragments is settled.

(4) In the list recognizing method according to the embodiment of the present invention, the building the undirected graph may comprise: building the undirected graph according to the neighborhood relations of the fragments, so that a relative position relationship of a fragment can be represented in the undirected graph, and building the undirected graph by using the MST or triangulation method, wherein through its position relationship of the neighbor the undirected graph can be generated. Thus it may ensure the accuracy and efficiency of the feature extracting for that the undirected graph can illustrate the features of the neighborhood relationship which provide convenience to extract the local features and the neighborhood relationship features of the fragments.

(5) In the list recognizing method according to the embodiment of the present invention, the step of detecting may comprise: detecting indent level of the bullet, relative indents and whether the indents of the bullet are identical to those of other bullets, so that the features of the bullet can be obtained, and the bullet can be trained and recognized better, which can provide a better way to recognize and extract the lists.

### BRIEF DESCRIPTION OF THE DRAWINGS

For a better understanding of the disclosure in the embodiments of the present invention, the present invention is described in retail as follows with reference to specific embodiments and accompanying drawings. Among the drawings:

FIG. 1 is a detail flowchart of the list recognizing method according to an embodiment of the present invention;

FIG. 2 is a detail flowchart of the list recognizing method according to another embodiment of the present invention;

FIG. 3 is a schematic diagram of a minimal spanning tree of fragments on a page in the table recognizing method according to an embodiment of the present invention; and

FIG. 4 is a diagram illustrating the list unit and the marked logic labels according to the list recognizing method according to an embodiment of the present invention.

### DETAILED DESCRIPTION OF THE PREFERRED EMBODIMENTS

### The First Embodiment

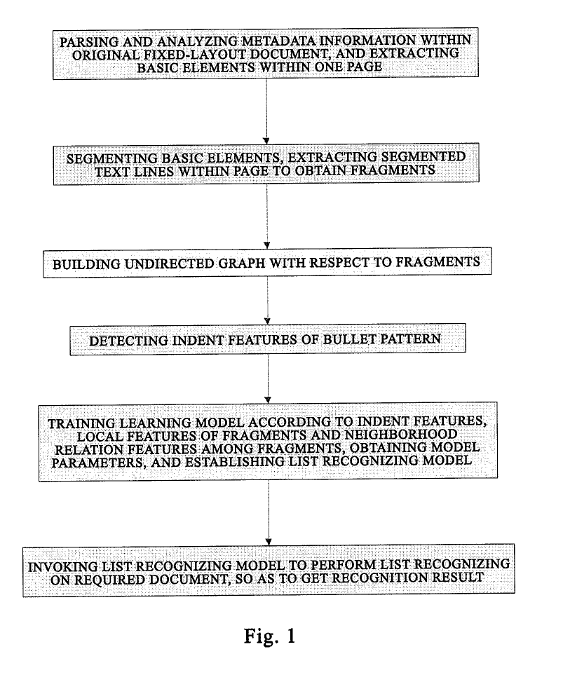

The present embodiment provides a list recognizing method, as illustrated in FIG. 1, comprising the steps of:

(1) parsing and analyzing metadata information within an original fixed-layout document, and extracting basic elements within a page. Here the basic elements within a page can be extracted and obtained by analysis tools in the prior arts, and the basic elements include text elements, image elements, graphic operation element information, and the like.

(2) segmenting the basic elements, extracting segmented text lines within the page to obtain fragments. In this step, continuous texts in the text lines are segmented into one fragment. The fragments are obtained by performing reasonable segmenting according to features of each of the basic elements based on the relationship with other basic elements around. The segmented text lines within the page are obtained by using a clustering method by cluster analysis for extracting segmented text lines within the page.

(3) building an undirected graph with respect to the fragments. At this time, the undirected graph is built by using neighborhood relations among the fragments by a Minimal Spanning Tree (MST) method. The neighborhood relations, that is to say, the neighborhood relation information, are neighbor relation information, position relation information and the like with respect to other fragments around the fragment.

(4) detecting indent features of a bullet according to the features of the basic elements, that is to say, detecting indent level of the bullet, relative indents and whether the indents of the bullet are identical to those of other bullets.

(5) training a learning model according to the indent features, local features of the fragments and neighborhood relation features among the fragments, obtaining model parameters, and establishing a list recognizing model. Herein the training model can choose a CRF model, or a structural SVM, or other learning models, and the machine, trained by the above-mentioned features, may build a model for recognizing the list in a self-learning way. The method keeps training by using a learning model, which can improve the trainable degree of the model, thereby improve the efficiency and accuracy of modeling, and ensure the accuracy of the list recognizing.

(6) invoking the list recognizing model to perform list recognizing on the required document, so as to get recognition results.

In the list recognizing method according to the embodiment of the present invention, machine learning method may recognize not only a list, but also the contextual relationship between the first line and its subsequent lines of a list, and realize analyzing and understanding a layout of the list of the fixed-layout document ultimately. The veracity of list recognizing to a fixed-layout document can be improved by analyzing the list logic function for recognizing even if the bullets of the first line of the list are various.

As other alternative embodiments, in step (5) of building a list recognizing model, the learning model may choose a CRF model, herein the process comprises: extracting the local features of each of the fragments in the undirected graph, classifying the local features and converting scores of classifications into a pseudo-probability function used as the unary feature function of the CRF model. In this embodiment, the local features of the fragments include the length-width ratio, the normalized area, the indent level, and the image texture features of the fragments, and the unary feature function is obtained by classifying by using a SVM classifier, selecting RBF, and converting the scores of the classifications into the pseudo-probability function.

And the binary feature function is obtained by extracting the neighborhood relation features among the fragments according to the neighborhood relations of the undirected graph. Then indent features, the local features of the fragments, and the neighborhood relation features among the fragments are inputted into the CRF model, then obtain the parameters of the model, and build a list recognizing model.

### The Second Embodiment

The present embodiment provides a list recognizing system, comprising:

an extracting unit, configured to parse and analyze metadata information within an original fixed-layout document, and extract basic elements within a page;

a segmenting unit, configured to segment the basic elements, extract segmented text lines within the page to obtain fragments, wherein the segmented text lines are extracted by using a clustering method and continuous texts in the text lines are segmented into one fragment;

a building unit, configured to build an undirected graph with respect to the fragments, wherein according to the neighborhood relations among the fragments, a Minimal Spanning Tree (MST) method is used to build the undirected graph;

a detecting unit, configured to detect indent features of a bullet according to features of the basic elements, i.e., to detect indent level of the bullet, relative indents and whether the indents of the bullets are identical to those of other bullets;

a modeling unit, configured to train a learning model according to the indent features, local features of the fragments and neighborhood relation features among the fragments, obtain model parameters, and establish a list recognizing model; and

an invoking unit, configured to invoke the list recognizing model to perform list recognizing on the required document, so as to get recognition results.

As a preferred embodiment of the present invention, the modeling unit comprises:

the first feature extraction subunit, configured to extract the local features of each of the fragments in the undirected graph, classify the local features and convert scores of classifications into a pseudo-probability function used as a unary feature function of a CRF model. The local features of the fragments comprise a length-width ratio, a normalized area, an indent level, and image texture features of the fragments. The local features of the fragments are classified by a SVM classifier, RBF is selected, and the scores of the classifications are converted into the pseudo-probability function.

the second feature extraction subunit, configured to extract the neighborhood relation features among the fragments as a binary feature function according to neighborhood relations of the undirected graph,

wherein the learning model is a CRF model.

### The Third Embodiment

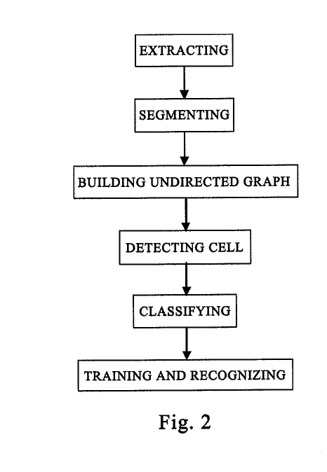

The flowchart of the list recognizing method corresponding to the list recognizing system according to the present embodiment, as shown in FIG. 2, comprises:

(1) an extracting step: parsing the metadata information within the original fixed-layout document by parsing engine, and extracting the basic graph elements which comprise the text elements, the image elements, and the graphic operation elements. The text elements include the text code, the font type, the font color, and the font size, etc. The image elements include nature images and synthesized images. The graphic operation elements include the operation information of drawing a line and drawing a picture.

(2) a segmenting step: clustering the text elements, the image elements, and the graphic operation elements, segmenting contents of the pages, and getting the fragments. Herein the clustering analysis method such as XY-CUT is used to extract the segmented text lines within the pages. The fragments are obtained according to the type of area of the text elements, the image elements, and the graphic operation elements.

(3) a building undirected graph step: building the undirected graph with respect to the fragments. The undirected graph is built according to the neighborhood relations among the fragments which mean the neighbor relations between the fragment and the other fragments around it, and herein is built by the MST method.

The principles of the minimum spanning tree are specifically as follows: A spanning tree of a page graph contains all the vertices of a graph. Given n vertices or page fragments, the spanning tree has n−1 edges. In the given undirected graph G=(V, E), eₛ₋ₜ represents a edge connecting vertex vₛ and vₜ (eₛ₋ₜεE), w(s, t) represents weight of the edge. If an acyclic subset F⊂E containing all the vertices and the total weight is minimal then F is the minimal spanning tree (MST) of graph G.

$$w ( F ) = {\sum }_{( {v}_{s} , {v}_{t} )} w ( s , t )$$

The MST is short for the Minimal Weight Spanning Tree actually.

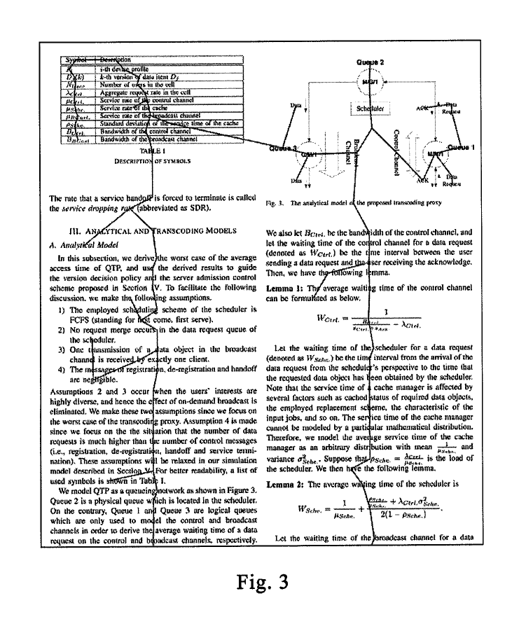

Therefore, using the MST method build the undirected graph with the fragments. FIG. 3 is a diagram illustrating the Minimal Spanning Tree of the fragments within a page.

Moreover, as another alternative embodiment, the Delaunay triangulation method can also be used to build the undirected graph. For its uniqueness, variety of geometry graphs, such as a Voronoi graph, EMST tree, and Gabriel graph and so on, with respect to the point set are related to the Delaunay triangulation method. The Delaunay triangulation method has two features: maximizing the minimal angle and the closest regularized triangulated network, and uniqueness (any four points cannot be concyclic). Therefore, the undirected graph can be built using the Delaunay triangulation method of the prior art.

(4) Detecting cell step: detecting the indent features of a bullet according to features of the basic elements, that is to say, detecting indent level of the bullet, relative indents and whether the indents of the bullets are identical to those of other bullets.

(5) Classifying step: extracting the local features of each of the fragments in the undirected graph, classifying by a Support Vector Machine (SVM) classifier, selecting Radial Basis Function (RBF), and converting the score of the classification based on the local features by Platt method to a pseudo-probability function used as the unary feature function of the Conditional Random Fields (CRF) model. Extracting the neighborhood relation features among the fragments used as the binary feature function according to the neighborhood relations of the undirected graph.

Support Vector Machine (SVM) is a trainable machine learning method. Its main idea can be summarized as: (1) It is targeted to analyze a linear separable situation, and for the linear inseparable situation, it can convert the linear inseparable samples in a low dimension input space into a high dimension feature space to make it linear separable by nonlinear mapping algorithm, which makes it possible that high feature space perform linear analysis on the non-linear features of the samples by using linear algorithm. In this step, SVM is used to classify. The “Radial Basic Function (RBF)”, is a radial symmetric scalar function. The score of the classification will be converted into pseudo-probability by RBF function by using Platt method.

(6) a training and recognizing step: training a learning model according to the indent features, local features of the fragments and neighborhood relation features among the fragments, obtaining model parameters, and establishing a list recognizing model.

Probabilistic graphical model, a general name for the model of expressing a correlation based on probability with graph models, can converge the multi-features and contextual information with unified probabilistic frame. In this embodiment, the neighborhood relationships are expressed as the undirected graph, which converts the problem of logic label into the problem of labeling the fragments based on undirected probabilistic graphical model.

Conditional Random Fields (CRF, or CRFs), a kind of discriminate probability model, and a type of random fields, generally is used to label or analyze sequences data, such as nature language characters or biological sequences. The CRF, uses a probabilistic graphical model, has the ability of expressing long distance dependence and overlapping characteristics, has the advantage of well solving the label (classification) offset and the like, and can globally normalize all features, and obtain a global optimal solution. The CRF is a typical judgment model in which joint probability can be written in a form of plenty of potential functions multiplying one by one, and in which the most common is linear chain CRF. The algorithm implementation of the CRF has several well-known open source projects currently, and has been widely applied in the academic research and the industry practice. Specifically, the advantage of the CRF model is that it has a better use of the observation of the fragments themselves and adaptive contextual information.

The list recognizing method of this embodiment can reduce the negative effects of the final labeling due to the uncertainty and ambiguity by multiple features and various contextual information, namely the unary local features and the binary neighborhood features. The unary features come from the features of the fragments themselves (that is to say, the features of neighborhood relationship among the fragments) mainly, and the binary features come from the relationship features of the neighbor fragments of the undirected graph (that is to say, the features of neighborhood relationship among the fragments) mainly. The object function of the CRF model is a negative log-likelihood function.

The specific process of this step is as follows: extracting the binary relation features between the text lines according to the neighborhood relationship of the undirected graph, which mainly include: whether two fragments are left alignment, right alignment or center alignment, whether two fragments have the same fonts and font size, whether two fragments have overlapped, and the width-radio, height-radio, and area-radio between two fragments and so on; building the unary and binary feature functions, training the CRF model to get the model's parameters, and obtaining the recognized result of the list recognizing at last.

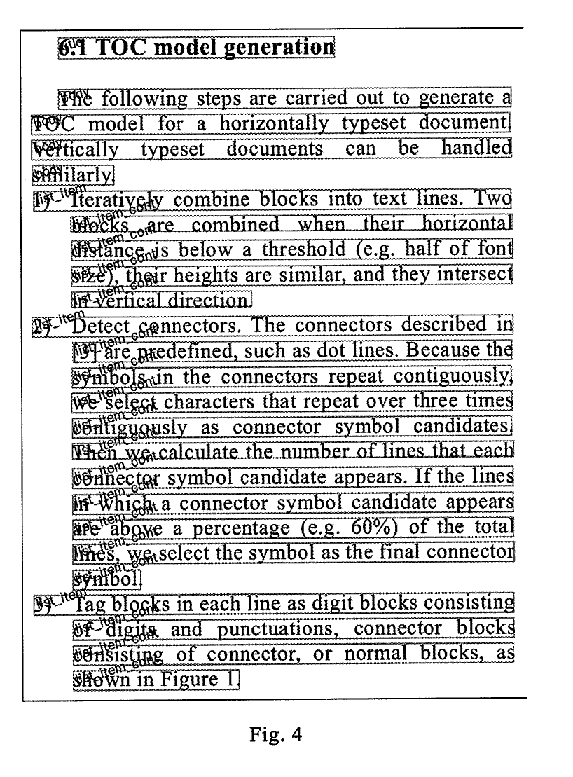

(7) Invoking the list recognizing model to perform list recognizing on the required document, so as to get recognition results. Thus this method is extracting lists, perform logical labeling, as shown in FIG. 4, and using a machine learning may recognize not only a list, but also the context relationship between the first line and its subsequent lines of a list, and accomplish fixed-layout analysis and understanding on the list of the fixed-layout document. The accuracy of list recognizing on the fixed-layout document can be improved even if the bullets of the first line of the list are various.

Obviously, the above embodiments are merely exemplary ones for illustrating the present invention, but are not intended to limit the present invention. Persons of ordinary skills in the art may derive other modifications and variations based on the above embodiments. Embodiments of the present invention are not exhaustively listed herein. Such modifications and variations derived still fall within the protection scope of the present invention.

Those skilled in the art shall understand that the embodiments may be described as illustrating methods, systems, or computer program products. Therefore, hardware embodiments, software embodiments, or hardware-plus-software embodiments may be used to illustrate the present invention. In addition, the present invention may further employ a computer program product which may be implemented by at least one non-transitory computer-readable storage medium with an executable program code stored thereon. The non-transitory computer-readable storage medium comprises but not limited to a disk memory, a CD-ROM, and an optical memory.

The present invention is described based on the flowcharts and/or block diagrams of the method, device (system), and computer program product. It should be understood that each process and/or block in the flowcharts and/or block diagrams, and any combination of the processes and/or blocks in the flowcharts and/or block diagrams may be implemented using computer program instructions. These computer program instructions may be issued to a computer, a dedicated computer, an embedded processor, or processors of other programmable data processing device to generate a machine, which enables the computer or the processors of other programmable data processing devices to execute the instructions to implement an apparatus for implementing specific functions in at least one process in the flowcharts and/or at least one block in the block diagrams.

These computer program instructions may also be stored a non-transitory computer-readable memory capable of causing a computer or other programmable data processing devices to work in a specific mode, such that the instructions stored on the non-transitory computer-readable memory implement a product comprising an instruction apparatus, wherein the instruction apparatus implements specific functions in at least one process in the flowcharts and/or at least one block in the block diagrams.

These computer program instructions may also be stored on a computer or other programmable data processing devices, such that the computer or the other programmable data processing devices execute a series of operations or steps to implement processing of the computer. In this way, the instructions, when executed on the computer or the other programmable data processing devices, implement the specific functions in at least one process in the flowcharts and/or at least one block in the block diagrams.

Although preferred embodiments are described, those skilled in the art may make modifications and variations to these embodiments based on the basic inventive concept of the present invention. Therefore, the preferred embodiments and all such modifications and variations shall fall within the protection scope subject to the appended claims.

What is claimed is:

1. A list recognizing method, comprising:
parsing and analyzing metadata information within an original fixed-layout document, and extracting basic elements within a page;
segmenting the basic elements, extracting segmented text lines within the page to obtain fragments;
building an undirected graph with respect to the fragments;
detecting indent features of a bullet according to features of the basic elements;
training a learning model according to the indent features, local features of the fragments and neighborhood relation features among the fragments, obtaining model parameters, and establishing a list recognizing model; and
invoking the list recognizing model to perform list recognizing on the required document, so as to get recognition results.

2. The method according to claim 1, wherein
the training a learning model according to the indent, local features of the fragments and the neighborhood relation features among the fragments, obtaining model parameters, and establishing a list recognizing model comprises:
extracting the local features of each of the fragments in the undirected graph, classifying the local features and converting scores of classifications into a pseudo-probability function used as a unary feature function of a Conditional Random Fields (CRF) model; and
extracting the neighborhood relation features among the fragments as a binary feature function according to neighborhood relations of the undirected graph,
wherein the learning model is a CRF model.

3. The method according to the claim 1, wherein
the segmenting the basic elements, extracting segmented text lines within the page to obtain fragments comprises: segmenting continuous texts in the text lines into one fragment.

4. The method according to the claim 1, wherein
the extracting segmented text lines within the page comprises: using clustering method for extracting segmented text lines.

5. The method according to the claim 1, wherein
the building an undirected graph with respect to the fragments comprises: building the undirected graph by using the neighborhood relations among the fragments.

6. The method according to the claim 1, wherein
the building an undirected graph with respect to the fragments comprises: using a Minimal Spanning Tree (MST) method or a triangulation method to build the undirected graph.

7. The method according to the claim 1, wherein
the detecting indent features of a bullet according to features of the basic elements comprises: detecting indent level of the bullet, relative indents and whether the indents of the bullets are identical to those of other bullets.

8. The method according to the claim 1, wherein
the local features of the fragments comprise a length-width ratio, a normalized area, an indent level, and image texture features of the fragments.

9. The method according to the claim 2, wherein
the extracting the local features of each of the fragments in the undirected graph, classifying the local features and converting scores of classifications into a pseudo-probability function comprises: classifying by a Support Vector Machine (SVM) classifier, selecting Radial Basis Function (RBF), and converting the scores of the classifications into the pseudo-probability function.

10. The method according to the claim 1, wherein
the indent features comprise an indent level of the bullet, relative indents and whether the indents of the bullets are identical to those of other bullets.

11. A list recognizing system, comprising:
an extracting unit, configured to parse and analyze metadata information within an original fixed-layout document, and extract basic elements within a page;
a segmenting unit, configured to segment the basic elements, extract segmented text lines within the page to obtain fragments;
a building unit, configured to build an undirected graph with respect to the fragments;
a detecting unit, configured to detect indent features of a bullet according to features of the basic elements;
a modeling unit, configured to train a learning model according to the indent features, local features of the fragments and neighborhood relation features among the fragments, obtain model parameters, and establish a list recognizing model; and
an invoking unit, configured to invoke the list recognizing model to perform list recognizing on the required document, so as to get recognition results.

12. The system according to the claim 11, wherein the modeling unit comprises:
a first feature extraction subunit, configured to extract the local features of each of the fragments in the undirected graph, classify the local features and convert scores of classifications into a pseudo-probability function used as a unary feature function of a CRF model;
a second feature extraction subunit, configured to extract the neighborhood relation features among the fragments as a binary feature function according to neighborhood relations of the undirected graph,
wherein the learning model is a CRF model.

13. The system according to the claim 11, wherein
the segmenting unit is configured to segment continuous texts in the text lines into one fragment.

14. The system according to the claim 11, wherein
the extracting unit is configured to extract the segmented text lines by using a clustering method.

15. The system according to the claim 11, wherein
the building unit is configured to build the undirected graph by using the neighborhood relations among the fragments.

16. The system according to the claim 11, wherein
the building unit is configured to use a MST method or a triangulation method to build the undirected graph.

17. The system according to the claim 11, wherein
the detecting unit is configured to detect indent level of the bullet, relative indents and whether the indents of the bullets are identical to those of other bullets.

18. The system according to the claim 11, wherein
the local features of the fragments comprise a length-width ratio, a normalized area, an indent level, and image texture features of the fragments.

19. The system according to the claim 12, wherein
the first feature extraction subunit is configured to classify by a SVM classifier, select RBF, and convert the scores of the classifications into the pseudo-probability function.

20. The system according to the claim 11, wherein
the indent features comprise an indent level of the bullet, relative indents and whether the indents of the bullets are identical to those of other bullets.
